(19) United States
(12) Patent Application Publication
(10) Pub. No.: US 2017/0157825 A1
(43) Pub. Date: Jun. 8, 2017

(54) METHOD FOR CONTINUOUS RECYCLING OF SCRAPS OF FIBER AND CLOTH THAT ARE BASED ON THERMOPLASTIC MATERIALS

(71) Applicant: Reifenhäuser GmbH & Co. KG Maschinenfabrik, Troisdorf (DE)

(72) Inventors: Thorsten Weber, Siegburg (DE); Tim POHL, Köln (DE)

(21) Appl. No.: 15/366,694

(22) Filed: Dec. 1, 2016

(30) Foreign Application Priority Data
Dec. 2, 2015 (EP) 15197545.5

(51) Int. Cl. B29C 47/00; B29C 47/76

(52) U.S. Cl. CPC B29C 47/0004; B29C 47/76; B29K 2105/26

(57) ABSTRACT

A method for continuous recycling of scraps of fiber and cloth that are based on thermoplastic materials in which when viewed in an extrusion direction, an extrusion apparatus is first supplied with the scrap composed of fibers and cloth and is then supplied with an additional fraction composed of thermoplastic polymers and additives, the supplied scrap and the additional fraction are mixed with each other in the extrusion apparatus, degassed, and then extruded together out of the extrusion apparatus forming an extrudate in which the scrap is embedded into the thermoplastic polymer of the additional fraction while at least partially retaining its fiber structure, with the mixing, degassing, and extruding of the scrap and the additional fraction being carried out at temperatures that lie below the softening temperature of at least one of the thermoplastic materials of the scrap.

### BACKGROUND OF THE INVENTION

Field of the Invention

This invention relates to a method for continuous recycling of scraps of fiber and cloth that are based on thermoplastic materials of the kind that accumulate, for example, in plastic recycling processes used on end-of-life vehicles.

Discussion of Related Art

Industry is endeavoring to recycle materially separated shredder scraps of fiber and cloth, for example from end-of-life vehicles. These scraps include fibers and cloth that are based on thermoplastic materials. In extrusion processes, it is known to convey scraps of this kind to single-screw or twin-screw extruders and with the aid thereof, to melt the scrap, homogenize it, and then process it into an extrudate. If the scrap is of different polymers, then additives and/or additional polymers are processed along with it in order to achieve a dimensionally stable composite of the extrudate obtained.

In this complete melting and extrusion of the thermoplastic materials of which the scrap is composed, it is problematic that with preceding sorting processes, the scraps have a high moisture content, which is an obstacle to a stable extrusion process. An extrusion process is also hampered by the fact that the scrap cannot be continuously supplied with a constant output to the extruder and furthermore, the scrap frequently contains impurities composed of dust, paper, elastomers, and the like, which impede the production of a high-quality component.

Because of these difficulties, recycling competes with and usually loses out to energetic utilization of scraps. Furthermore, in the known extrusion methods, the existing positive mechanical properties of the fibers and cloth are lost and only low-quality products are produced.

### SUMMARY OF THE INVENTION

One object of this invention is to provide a method for continuous recycling of scraps of fiber and cloth that are based on thermoplastic materials, which enables efficient and economical recycling of the fibers and cloth to produce a high-quality product in which the component properties obtained bring added value that permits a positive result in the economical comparison to thermal utilization.

This object and others are attained according to this invention with a method according to the features described in this specification and the claims, including the dependent claims.

In one embodiment of this invention, there is supplied an extrusion apparatus, viewed in the extrusion direction, first with the scrap composed of fibers and cloth and subsequently with an additional fraction composed of thermoplastic polymers and additives, then mixing the supplied scrap and the additional fraction with each other in the extrusion apparatus, degassing them, and then extruding them together out of the extrusion apparatus and forming an extrudate in which the scrap is embedded into the thermoplastic polymer of the additional fraction while at least partially retaining its fiber structure. This is achieved if the mixing, degassing, and extruding of the scrap and the additional fractions is carried out at temperatures below the softening temperature of at least one of the thermoplastic materials of the scraps.

Through the use of the method according to this invention, an extrudate is thus obtained in which the thermoplastic polymer of the additional fraction exists in the form of a matrix material and is reinforced by fibers and pieces of cloth that are embedded, but are largely contained in the structure so that an extrudate with particularly good mechanical properties is obtained, which is suitable for high-quality applications with correspondingly high demands for mechanical strength and the like.

According to this invention, the extrusion of scrap composed of fibers and cloth and the other fractions is thus carried out in a shared extrusion apparatus. Depending on the thermoplastic materials in the scrap, a corresponding temperature control in the extrusion apparatus and a corresponding selection of raw materials, in particular polymers, of the additional fraction are carried out so that the temperature inside the extrusion apparatus in any case remains below the softening temperature of at least one thermoplastic material of the scrap so that the fiber structure is retained. This requires that possible thermoplastic polymers of the additional fraction particularly include those with a melting point that lies below the softening temperature of the thermoplastic materials that are processed as part of the scrap.

According to one embodiment of this invention, before or after the supply of the additional fraction, the scrap is heated in the extrusion apparatus to a temperature of 95 to 105 degrees Celsius, preferably about 100 degrees Celsius, and an atmospheric degassing and/or a degassing that is forced through the production of a negative pressure is carried out in the extrusion apparatus either on the scrap or on the scrap that has already been mixed with the additional fraction. In this case, volatile impurities on the surface of the scrap are removed and the moisture content is extracted from the scrap at least until a residual moisture is established that does not impede the extrusion process since the gas transition temperature of the scrap depends on the residual moisture. By regulating the moisture content of the scrap, it is possible to ensure that the processing of the supplied thermoplastic polymer and the additives of the additional fraction takes place below the softening temperature of at least one of the thermoplastic materials of the scrap.

According to some embodiments of this invention, the additional fraction can be composed of thermoplastic polymers and additives, which can, for example, be supplied to the extrusion apparatus in the non-molten state and can then be processed together with the scrap to produce the extrudate.

According to another embodiment of this invention, the additional fraction is alternatively plasticized before being supplied into the extrusion apparatus in a separate plasticizing extruder, for example a single-screw extruder, and is supplied from this in the plasticized state to the extrusion apparatus, whereupon the scrap is then degassed together with this already plasticized additional fraction. As a result of the additional fraction being supplied in an already plasticized state, the scrap is also less intensively heated during processing inside the extrusion apparatus so that the temperature can be reliably kept below the softening temperature of at least one thermoplastic material of the scrap. The already molten polymer can also be more easily brought into the interstices that are inevitably present in the scrap inside the extrusion apparatus since these are filled by the second fraction that is in the plasticized state.

The additional fraction that is supplied to the extrusion apparatus already in the plasticized state can in principle be supplied to the extrusion apparatus at any suitable location, but this is always carried out downstream of the supply of the scrap, viewed in the extrusion direction. In this connection, though, it is not necessarily mandatory to maintain a greater distance and instead it is also possible to supply the already molten additional fraction to the extrusion apparatus immediately after the scrap in order for the scrap to already be preheated early in the process.

Furthermore, after the plasticization in the plasticizing extruder, the additional fraction can also be divided, for example, into two partial flows, with the partial flows being supplied to the extrusion apparatus at successive positions, viewed in the extrusion direction. For example, a first partial flow can be supplied to the extrusion apparatus as immediately as possible after the supply of the scrap, whereas another partial flow is supplied to the extrusion apparatus at a point further downstream, viewed in the extrusion direction.

The method according to this invention requires that in the sense of the fiber structure contained in the extrudate, fibers and cloth are present in the scrap, which have a high heat distortion temperature due to the thermoplastic materials used. This is the case, for example, with fibers and cloth that are based on polyamide or polyester.

According to another embodiment of this invention, the scrap is supplied to the extrusion apparatus in a proportion of at least 50% of the extrudate contained and is processed into a tube, a profile, a cable, or a film or plate, into a core material of a multilayered composite, such as a co-extrusion composite, or a melt strand. It is also possible to produce three-dimensional components by extruding into a pressing mold or pressing tool in order to then produce a molded part or else the extrudate is formed into a granulate, which then undergoes further processing, for example, in an injection molding process.

### BRIEF DESCRIPTION OF THE DRAWINGS

Details of this invention are explained in conjunction with exemplary embodiments, wherein:

FIG. 1 schematically shows an extrusion apparatus, according to a first embodiment of this invention;

FIG. 2 shows an extrusion apparatus, according to a second embodiment of this invention; and

FIG. 3 shows an extrusion apparatus, according to a third embodiment of this invention.

### DETAILED DESCRIPTION OF THE INVENTION

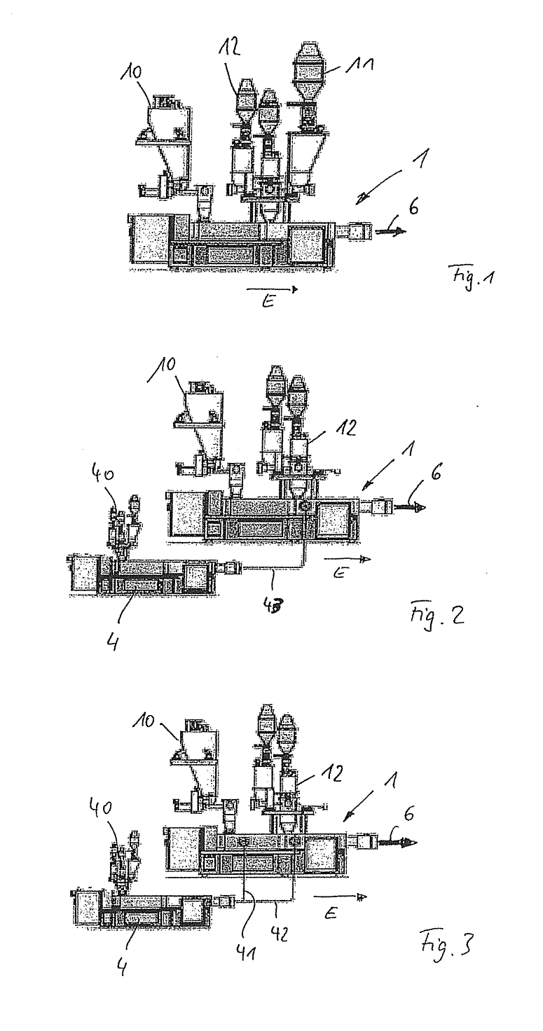

FIGS. 1-3 show various embodiments of extrusion apparatuses, which are labeled with the reference numeral 1 and are used for carrying out the above-described method. The extrusion apparatus can optionally be a single-screw extruder or twin-screw extruder of an intrinsically known design, a selection made by the person skilled in the art depending on the application.

In the exemplary embodiment according to FIG. 1, viewed in the extrusion direction E, the extrusion apparatus 1 first has a feeder 10 for scraps of or composed of fibers and cloth based on thermoplastic materials such as shredder flows or fiber/cloth fractions, for example from recycling processes of end-of-life vehicles. This scrap is first compressed and homogenized in the extrusion apparatus, before a thermoplastic polymer supplied by a metering station 11 and suitable additives supplied by another metering station 12 are supplied together to the extrusion apparatus 1 at a point downstream, viewed in the extrusion direction E and in the extrusion apparatus 1, together with the already supplied scrap, are mixed, degassed, and extruded together out of the extrusion apparatus 1 forming an extrudate 6. In this connection, the temperature control takes place inside the extrusion apparatus 1 so that the mixing, degassing, and extruding of the scrap and the additional fraction are carried out at temperatures that lie below the softening temperature of at least one of the thermoplastic materials of the scrap so that in the extrudate 6, the scrap is embedded into the thermoplastic polymer of the additional fraction while partially retaining its fiber structure, which consequently forms a matrix material for accommodating the fibers and cloth remnants.

A typical recipe can, for example, be of or composed of the following:
40-80% scrap (fibers, cloth, etc.);
20-50% thermoplastic polymer (e.g. HDPE, MDPE, PP, EVA, or recycling shredder products);
5-50% additives (coupling agents, colorants, lubricants, etc.)

Degassing requires a temperature in the extrusion apparatus 1 of preferably 100° C. or more, while temperatures of approximately 120° C. to 160° C. are provided for the homogenization and molding.

By comparison, FIG. 2 shows a modified system in which the supply of the scrap and the additives is carried out by the corresponding metering units 10, 12 analogous to the embodiment in FIG. 1, but the polymer, which together with the additives forms the additional fraction, is first separately supplied to a plasticizing extruder 4 by a metering station 40 and plasticized and is then supplied to the extrusion apparatus 1 by a corresponding supply line 43 in an already plasticized state.

The exemplary embodiment according to FIG. 3 shows a system that has once again been modified by comparison, in which the thermoplastic polymer from the plasticizing extruder 4 is divided into two partial flows 41, 42, with the first partial flow 41 being supplied to the extrusion apparatus 1 immediately after the addition of the scrap, while the other partial flow 42 is supplied at a downstream position viewed in the extrusion direction E together with the additives that are dispensed into the extrusion apparatus 1 by the metering station 12.

The extrudate 6 obtained in all of the embodiments illustrated above can, for example, be processed into a tube, a profile, a cable, a film, a plate, or a core material of a multilayered composite such as a co-extrusion composite or can constitute or form a melt strand, which is subsequently pressed to form a three-dimensional component, for example, or also formed into a granulate, which can then undergo further processing, for example, in an injection molding process.

The obtained extrudates 6 feature high-quality mechanical properties due to the retention of the fiber structure in the polymer serving as the matrix material so that in the end, a fiber-reinforced polymer of or composed of the scraps and the additional fraction is obtained.

European Patent Application EP 15197545.5, filed 2 Dec. 2015, the priority document corresponding to this invention, to which a foreign priority benefit is claimed under Title 35, United States Code, Section 119, and its entire teachings are incorporated, by reference, into this specification.

What is claimed is:

1. A method for continuous recycling of scraps of fiber and cloth based on thermoplastic materials in which viewed in an extrusion direction (E), an extrusion apparatus (1) is first supplied with the scraps of fibers and cloth and is then supplied with an additional fraction of thermoplastic polymers and additives, the supplied scrap and the additional fraction are mixed with each other in the extrusion apparatus (1), degassed, and then extruded together out of the extrusion apparatus (1) forming an extrudate (6) in which the scrap is embedded into the thermoplastic polymers of the additional fraction while at least partially retaining a fiber structure, with the mixing, degassing, and extruding of the scrap and the additional fraction being carried out at temperatures below a softening temperature of at least one of the thermoplastic materials of the scrap.

2. The method according to claim 1, wherein before or after the supply of the additional fraction, the scrap is heated in the extrusion apparatus to a temperature of 100° C. to 160° C. and is degassed atmospherically or by a negative pressure.

3. The method according to claim 2, wherein before the supply of the additional fraction into the extrusion apparatus (1), the additional fraction is plasticized in a separate plasticizing extruder (4) and is supplied from this in a plasticized state to the extrusion apparatus (1) and then the scrap is degassed together with the additional fraction.

4. The method according to claim 3, wherein after the plasticization in the plasticizing extruder (4), the additional fraction is divided into two partial flows and the partial flows are supplied to the extrusion apparatus at successive positions of the extrusion apparatus (1), viewed in the extrusion direction (E).

5. The method according to claim 4, wherein the thermoplastic polymers and the additives of the additional fraction are supplied to the extrusion apparatus (1) together or at successive positions, viewed in the extrusion direction (E).

6. The method according to claim 5, wherein the fibers and cloth of the scrap are polyamide-based or polyester-based.

7. The method according to claim 6, wherein the scrap is supplied to the extrusion apparatus (1) in a proportion of at least 50% of the extrudate (6).

8. The method according to claim 7, wherein a moisture content of the scrap is regulated.

9. The method according to claim 8, wherein the extrudate (6) is formed into a tube, a profile, a cable, a film, a plate, a core material of a multilayered composite, a melt strand, or a granulate.

10. The method according to claim 1, wherein before the supply of the additional fraction into the extrusion apparatus (1), the additional fraction is plasticized in a separate plasticizing extruder (4) and is supplied from this in a plasticized state to the extrusion apparatus (1) and then the scrap is degassed together with the additional fraction.

11. The method according to claim 10, wherein after the plasticization in the plasticizing extruder (4), the additional fraction is divided into two partial flows and the partial flows are supplied to the extrusion apparatus at successive positions of the extrusion apparatus (1), viewed in the extrusion direction (E).

12. The method according to claim 1, wherein the thermoplastic polymers and the additives of the additional fraction are supplied to the extrusion apparatus (1) together or at successive positions, viewed in the extrusion direction (E).

13. The method according to claim 1, wherein the fibers and cloth of the scrap are polyamide-based or polyester-based.

14. The method according to claim 1, wherein the scrap is supplied to the extrusion apparatus (1) in a proportion of at least 50% of the extrudate (6).

15. The method according to claim 1, wherein a moisture content of the scrap is regulated.

16. The method according to claim 1, wherein the extrudate (6) is formed into a tube, a profile, a cable, a film, a plate, a core material of a multilayered composite, a melt strand, or a granulate.
